(19) United States
(12) Patent Application Publication
(10) Pub. No.: US 2026/0333050 A1
(43) Pub. Date: Oct. 22, 2026

(54) METHODS AND APPARATUS OF POSITIONING INTEGRITY COMPUTATION

(71) Applicant: Lenovo (Beijing) Ltd., Beijing (CN)

(72) Inventors: Robin Rajan Thomas, Bad Nauheim (DE); Jie Hu, Beijing (CN); Hyung-Nam Choi, Ottobrunn (DE)

(73) Assignee: Lenovo (Beijing) Limited, Beijing (CN)

(21) Appl. No.: 19/110,540

(22) PCT Filed: Nov. 17, 2022
(86) PCT No.: PCT/CN2022/132580

§ 371 Date: Mar. 11, 2025

(51) Int. Cl. H04W 12/104; H04L 5/00; H04W 12/106; H04W 64/00

(52) U.S. Cl. CPC H04W 12/104; H04L 5/0048; H04W 12/106; H04W 64/00

(57) ABSTRACT

Methods and apparatus of positioning integrity computation are disclosed. The apparatus includes: a receiver that receives a request message for assistance data of Radio Access Technology (RAT)-dependent positioning integrity information and/or integrity service alert information; wherein the request message comprises: a type of positioning method, and/or an indication of frequency for reporting of the RAT-dependent positioning integrity information and/or the integrity service alert information; a processor that determines at least one Positioning Reference Signal (PRS) unsuitable for satisfying an integrity condition; and a transmitter that transmits a response message indicating the unsuitable PRS, allowing the unsuitable PRS to be omitted from transmission and/or measurement.

### FIELD

The subject matter disclosed herein relates generally to wireless communication and more particularly relates to, but not limited to, methods and apparatus of positioning integrity computation.

### BACKGROUND

The following abbreviations and acronyms are herewith defined, at least some of which are referred to within the specification:

Third Generation Partnership Project (3GPP), 5th Generation (5G), New Radio (NR), 5G Node B (gNB), Long Term Evolution (LTE), LTE Advanced (LTE-A), E-UTRAN Node B (eNB), Universal Mobile Telecommunications System (UMTS), Worldwide Interoperability for Microwave Access (WiMAX), Evolved UMTS Terrestrial Radio Access Network (E-UTRAN), Wireless Local Area Networking (WLAN), Orthogonal Frequency Division Multiplexing (OFDM), Single-Carrier Frequency-Division Multiple Access (SC-FDMA), Downlink (DL), Uplink (UL), User Equipment (UE), Network Equipment (NE), Radio Access Technology (RAT), Receive or Receiver (RX, or Rx), Transmit or Transmitter (TX, or Tx), Channel State Information (CSI), Channel State Information Reference Signal (CSI-RS), Frequency Division Multiple Access (FDMA), Index/Identifier (ID), Information Element (IE), Industrial Internet of Things (IIoT), Positioning Reference Signal (PRS), Radio Access Network (RAN), Radio Resource Control (RRC), Reference Signal (RS), Reference Signal Received Power (RSRP), Reference Signal Received Quality (RSRQ), Round Trip Time (RTT), Sidelink (SL), Sounding Reference Signal (SRS), Synchronization Signal Block (SSB), Transmission Reception Point (TRP), Frequency Range 1 (FR1), Frequency Range 2 (FR2), The interface between the gNB and the 5GCN (NG), Radio Resource Management (RRM), Synchronization Signal (SS), Technical Report (TR), Technical Specification (TS), Universal Terrestrial Radio Access (UTRA), CSI reference signal received power (CSI-RSRP), CSI reference signal received quality (CSI-RSRQ), Evolved Universal Terrestrial Radio Access (E-UTRA), For Further Study (FFS), Global Navigation Satellite System (GNSS), NR Cell Global Identifier (NCGI), node providing E-UTRA user plane and control plane protocol terminations towards the UE, and connected via the NG interface to the 5GC (ng-eNB), NG Radio Access Network (NG-RAN), StandAlone (SA), SS reference signal received power (SS-RSRP), SS reference signal received quality (SS-RSRQ), DownLink-Positioning Reference Signal (DL-PRS), Non Line of Sight (NLOS), Line of Sight (LOS), Alert Limit (AL), Access Point (AP), Angle-of-Arrival (AoA), Absolute Radio Frequency Channel Number (ARFCN), Cell-ID (positioning method) (CID), Angle of Departure (AoD), Time Difference of Arrival (TDOA), Do Not Use (DNU), Enhanced Cell-ID (positioning method) (E CID), Global Positioning System (GPS), Inertial Measurement Unit (IMU), Interface Specification (IS), Location Management Function (LMF), LTE Positioning Protocol (LPP), Metropolitan Beacon System (MBS), Multiple-Round Trip Time (Multi-RTT), NR Positioning Protocol Annex (NRPPa), Observed Time Difference Of Arrival (OTDOA), Protection Level (PL), Reference Signal Time Difference (RSTD), Space Based Augmentation System (SBAS), Time to Alert (TTA), Terrestrial Beacon System (TBS), Target Integrity Risk (TIR), Location Service (LCS), Relative Time Of Arrival (RTOA), Reference Signal Received Path Power (RSRPP), Bandwidth Part (BWP), Multiple Input Multiple Output (MIMO), Positioning System Information Block (posSIB), Zenith of arrival (ZOA).

In wireless communication, such as a Third Generation Partnership Project (3GPP) mobile network, a wireless mobile network may provide a seamless wireless communication service to a wireless communication terminal having mobility, i.e., user equipment (UE). The wireless mobile network may be formed of a plurality of base stations and a base station may perform wireless communication with the UEs.

The 5G New Radio (NR) is the latest in the series of 3GPP standards which supports very high data rate with lower latency compared to its predecessor LTE (4G) technology. Two types of frequency range (FR) are defined in 3GPP. Frequency of sub-6 GHz range (from 450 to 6000 MHz) is called FR1 and millimeter wave range (from 24.25 GHz to 52.6 GHz) is called FR2. The 5G NR supports both FR1 and FR2 frequency bands.

Enhancements on multi-TRP/panel transmission including improved reliability and robustness with both ideal and non-ideal backhaul between these TRPs (Transmission Reception Points) are studied. A TRP is an apparatus to transmit and receive signals, and is controlled by a gNB through the backhaul between the gNB and the TRP.

Integrity methods refer to the measure of trust and associated procedures that ensure the estimated position calculated by the positioning calculation entity can be trustable with a high degree of certainty. The positioning calculation entity may, for example, include the LMF (location server) for UE-assisted positioning methods, or the target-UE for UE-based positioning methods.

In Release 17 of 3GPP specifications, UE based GNSS integrity was introduced. It allows the UE to determine and report to the location server the integrity results of the calculated position which is determined using GNSS positioning methods. In Release 18, a Study Item Description (SID) was approved to study RAT-dependent integrity methods, which measure the trust of a UE's position estimate computed using positioning techniques such as DL-TDoA, DL-AoD, Multi-RTT, UL-TDoA and UL-AoA.

A key starting point is to identify the error sources that contribute to the inaccuracy of certain RAT-dependent positioning methods, which may affect the integrity of the final positioning estimate. Upon identification of the error sources, suitable procedures and signalling may be developed to notify a Location Service (LCS) client when such methods do not fulfil the conditions for the intended positioning operation.

### SUMMARY

Methods and apparatus of positioning integrity computation are disclosed.

According to a first aspect, there is provided an apparatus, including: a receiver that receives a request message for assistance data of Radio Access Technology (RAT)-dependent positioning integrity information and/or integrity service alert information; wherein the request message comprises: a type of positioning method, and/or an indication of frequency for reporting of the RAT-dependent positioning integrity information and/or the integrity service alert information; a processor that determines at least one Positioning Reference Signal (PRS) unsuitable for satisfying an integrity condition; and a transmitter that transmits a response message indicating the unsuitable PRS, allowing the unsuitable PRS to be omitted from transmission and/or measurement.

According to a second aspect, there is provided an apparatus, including: a transmitter that transmits a request message for assistance data for Radio Access Technology (RAT)-dependent positioning integrity information and/or integrity service alert information; wherein the request message comprises: a type of positioning method and/or an indication of frequency for reporting of the positioning integrity information and/or the integrity service alert information; and a receiver that receives a response message indicating at least one Positioning Reference Signal (PRS), allowing the unsuitable PRS to be omitted from transmission and/or measurement; wherein the unsuitable PRS is determined to be unsuitable for satisfying an integrity condition.

According to a third aspect, there is provided a method, including: receiving, by a receiver, a request message for assistance data of Radio Access Technology (RAT)-dependent positioning integrity information and/or integrity service alert information; wherein the request message comprises: a type of positioning method, and/or an indication of frequency for reporting of the RAT-dependent positioning integrity information and/or the integrity service alert information; determining, by a processor, at least one Positioning Reference Signal (PRS) unsuitable for satisfying an integrity condition; and transmitting, by a transmitter, a response message indicating the unsuitable PRS, allowing the unsuitable PRS to be omitted from transmission and/or measurement.

According to a fourth aspect, there is provided a method, including: transmitting, by a transmitter, a request message for assistance data for Radio Access Technology (RAT)-dependent positioning integrity information and/or integrity service alert information; wherein the request message comprises: a type of positioning method and/or an indication of frequency for reporting of the positioning integrity information and/or the integrity service alert information; and receiving, by a receiver, a response message indicating at least one Positioning Reference Signal (PRS), allowing the unsuitable PRS to be omitted from transmission and/or measurement; wherein the unsuitable PRS is determined to be unsuitable for satisfying an integrity condition.

### BRIEF DESCRIPTION OF THE DRAWINGS

A more particular description of the embodiments will be rendered by reference to specific embodiments illustrated in the appended drawings. Given that these drawings depict only some embodiments and are not therefore considered to be limiting in scope, the embodiments will be described and explained with additional specificity and details through the use of the accompanying drawings, in which:

FIG. 1 is a schematic diagram illustrating a wireless communication system in accordance with some implementations of the present disclosure;

FIG. 2 is a schematic block diagram illustrating components of user equipment (UE) in accordance with some implementations of the present disclosure;

FIG. 3 is a schematic block diagram illustrating components of network equipment (NE) in accordance with some implementations of the present disclosure;

FIG. 4A is a schematic diagram illustrating an example of NR beam-based positioning in accordance with some implementations of the present disclosure;

FIG. 4B is a schematic diagram illustrating an example of Multi-cell RTT procedure in accordance with some implementations of the present disclosure;

FIG. 4C is a schematic diagram illustrating an example of relative range estimation using existing single gNB RTT positioning framework in accordance with some implementations of the present disclosure;

FIG. 5 is a schematic diagram illustrating an example of enabling indication of integrity and/or integrity service alerts for UE-based positioning integrity via request/response signalling with LMF in accordance with some implementations of the present disclosure;

FIG. 6 is a schematic diagram illustrating an example of enabling integrity result reporting for UE-based positioning integrity in accordance with some implementations of the present disclosure;

FIG. 7 is a flow chart illustrating steps of positioning integrity computation by LMF in accordance with some implementations of the present disclosure; and

FIG. 8 is a flow chart illustrating steps of positioning integrity computation by UE in accordance with some implementations of the present disclosure.

### DETAILED DESCRIPTION

As will be appreciated by one skilled in the art, aspects of the embodiments may be embodied as a system, an apparatus, a method, or a program product. Accordingly, embodiments may take the form of an all-hardware embodiment, an all-software embodiment (including firmware, resident software, micro-code, etc.) or an embodiment combining software and hardware aspects.

Furthermore, one or more embodiments may take the form of a program product embodied in one or more computer readable storage devices storing machine readable code, computer readable code, and/or program code, referred to hereafter as “code.” The storage devices may be tangible, non-transitory, and/or non-transmission.

Reference throughout this specification to “one embodiment,” “an embodiment,” “an example,” “some embodiments,” “some examples,” or similar language means that a particular feature, structure, or characteristic described is included in at least one embodiment or example. Thus, instances of the phrases “in one embodiment,” “in an example,” “in some embodiments,” and similar language throughout this specification may, but do not necessarily, all refer to the same embodiment(s). It may or may not include all the embodiments disclosed. Features, structures, elements, or characteristics described in connection with one or some embodiments are also applicable to other embodiments, unless expressly specified otherwise. The terms “including,” “comprising,” “having,” and variations thereof mean “including but not limited to,” unless expressly specified otherwise.

An enumerated listing of items does not imply that any or all of the items are mutually exclusive, unless expressly specified otherwise. The terms “a,” “an,” and “the” also refer to “one or more”, and similarly items expressed in plural form also include reference to one or multiple instances of the item, unless expressly specified otherwise.

Throughout the disclosure, the terms “first,” “second,” “third,” and etc. are all used as nomenclature only for references to relevant devices, components, procedural steps, and etc. without implying any spatial or chronological orders, unless expressly specified otherwise. For example, a “first device” and a “second device” may refer to two separately formed devices, or two parts or components of the same device. In some cases, for example, a “first device” and a “second device” may be identical, and may be named arbitrarily. Similarly, a “first step” of a method or process may be carried or performed after, or simultaneously with, a “second step.”

It should be understood that the term “and/or” as used herein refers to and includes any and all possible combinations of one or more of the associated listed items. For example, “A and/or B” may refer to any one of the following three combinations: existence of A only, existence of B only, and co-existence of both A and B. The character “/” generally indicates an “or” relationship of the associated items. This, however, may also include an “and” relationship of the associated items. For example, “A/B” means “A or B,” which may also include the co-existence of both A and B, unless the context indicates otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of various embodiments are described below with reference to schematic flowchart diagrams and/or schematic block diagrams of methods, apparatuses, systems, and program products. It will be understood that each block of the schematic flowchart diagrams and/or schematic block diagrams, as well as combinations of blocks in the schematic flowchart diagrams and/or schematic block diagrams, may be implemented by code. This code may be provided to a processor of a general-purpose computer, special purpose computer, or other programmable data processing apparatus to produce a machine, such that the instructions executed via the processor of the computer or other programmable data processing apparatus create a means for implementing the functions or acts specified in the schematic flowchart diagrams and/or schematic block diagrams.

The code may also be stored in a storage device that can direct a computer, other programmable data processing apparatus, or other devices to function in a particular manner, such that the instructions stored in the storage device produce an article of manufacture including instructions which implement the function or act specified in the schematic flowchart diagrams and/or schematic block diagrams.

The schematic flowchart diagrams and/or schematic block diagrams in the Figures illustrate the architecture, functionality, and operation of possible implementations of different apparatuses, systems, methods, and program products according to various embodiments. In this regard, each block in the schematic flowchart diagrams and/or schematic block diagrams may represent a module, segment, or portion of code, which includes one or more executable instructions of the code for implementing the specified logical function(s). One skilled in the relevant art will recognize, however, that the flowchart diagrams need not necessarily be practiced in the sequence shown and are able to be practiced without one or more of the specific steps, or with other steps not shown.

It should also be noted that, in some alternative implementations, the functions noted in the identified blocks may occur out of the order noted in the Figures. For example, two blocks shown in succession may, in fact, be substantially executed in concurrence, or the blocks may sometimes be executed in reverse order, depending upon the functionality involved.

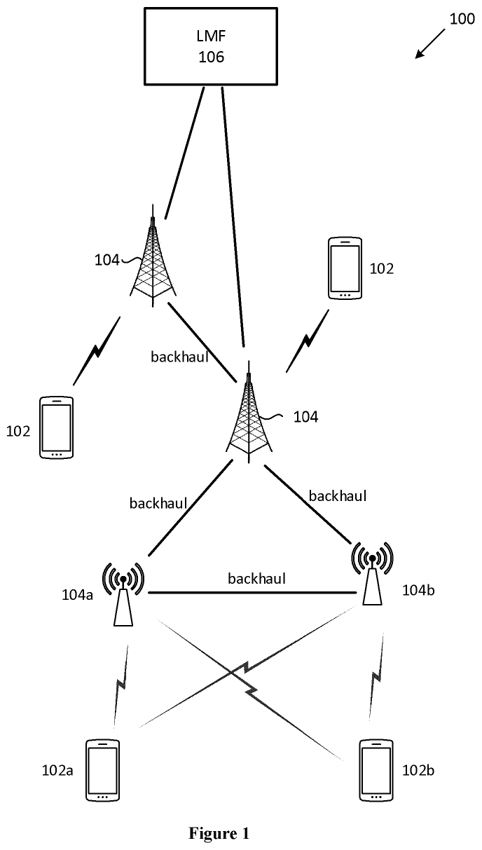

FIG. 1 is a schematic diagram illustrating a wireless communication system. It depicts an embodiment of a wireless communication system 100. In one embodiment, the wireless communication system 100 may include a user equipment (UE) 102 and a network equipment (NE) 104. Even though a specific number of UEs 102 and NEs 104 is depicted in FIG. 1, one skilled in the art will recognize that any number of UEs 102 and NEs 104 may be included in the wireless communication system 100.

The UEs 102 may be referred to as remote devices, remote units, subscriber units, mobiles, mobile stations, users, terminals, mobile terminals, fixed terminals, subscriber stations, user terminals, apparatus, devices, user device, or by other terminology used in the art.

In one embodiment, the UEs 102 may be autonomous sensor devices, alarm devices, actuator devices, remote control devices, or the like. In some other embodiments, the UEs 102 may include computing devices, such as desktop computers, laptop computers, personal digital assistants (PDAs), tablet computers, smart phones, smart televisions (e.g., televisions connected to the Internet), set-top boxes, game consoles, security systems (including security cameras), vehicle on-board computers, network devices (e.g., routers, switches, modems), or the like. In some embodiments, the UEs 102 include wearable devices, such as smart watches, fitness bands, optical head-mounted displays, or the like. The UEs 102 may communicate directly with one or more of the NEs 104.

The NE 104 may also be referred to as a base station, an access point, an access terminal, a base, a Node-B, an eNB, a gNB, a Home Node-B, a relay node, an apparatus, a device, or by any other terminology used in the art. Throughout this specification, a reference to a base station may refer to any one of the above referenced types of the network equipment 104, such as the eNB and the gNB.

The NEs 104 may be distributed over a geographic region. The NE 104 is generally part of a radio access network that includes one or more controllers communicably coupled to one or more corresponding NEs 104. The radio access network is generally communicably coupled to one or more core networks, which may be coupled to other networks, like the Internet and public switched telephone networks. These and other elements of radio access and core networks are not illustrated, but are well known generally by those having ordinary skill in the art.

In one implementation, the wireless communication system 100 is compliant with a 3GPP 5G new radio (NR). In some implementations, the wireless communication system 100 is compliant with a 3GPP protocol, where the NEs 104 transmit using an OFDM modulation scheme on the DL and the UEs 102 transmit on the uplink (UL) using a SC-FDMA scheme or an OFDM scheme. More generally, however, the wireless communication system 100 may implement some other open or proprietary communication protocols, for example, WiMAX. The present disclosure is not intended to be limited to the implementation of any particular wireless communication system architecture or protocol.

The NE 104 may serve a number of UEs 102 within a serving area, for example, a cell (or a cell sector) or more cells via a wireless communication link. The NE 104 transmits DL communication signals to serve the UEs 102 in the time, frequency, and/or spatial domain.

Communication links are provided between the NE 104 and the UEs 102a, 102b, which may be NR UL or DL communication links, for example. Some UEs 102 may simultaneously communicate with different Radio Access Technologies (RATs), such as NR and LTE. Direct or indirect communication link between two or more NEs 104 may be provided.

The NE 104 may also include one or more transmit receive points (TRPs) 104a. In some embodiments, the network equipment may be a gNB 104 that controls a number of TRPs 104a. In addition, there is a backhaul between two TRPs 104a. In some other embodiments, the network equipment may be a TRP 104a that is controlled by a gNB.

Communication links are provided between the NEs 104, 104a and the UEs 102, 102a, respectively, which, for example, may be NR UL/DL communication links. Some UEs 102, 102a may simultaneously communicate with different Radio Access Technologies (RATs), such as NR and LTE.

In some embodiments, the UE 102a may be able to communicate with two or more TRPs 104a that utilize a non-ideal or ideal backhaul, simultaneously. A TRP may be a transmission point of a gNB. Multiple beams may be used by the UE and/or TRP(s). The two or more TRPs may be TRPs of different gNBs, or a same gNB. That is, different TRPs may have the same Cell-ID or different Cell-IDs. The terms “TRP”, “Transmission Reception Point”, and “transmitting-receiving identity” may be used interchangeably throughout the disclosure.

The core network includes a location server, or Location Management Function (LMF) 106. The LMF 106 in the core network may be implemented as a hardware component, a software program or module, or a combination of hardware and software. The base station or gNB 104 may be communicably coupled to the LMF106 of the core network through wired or wireless communication links.

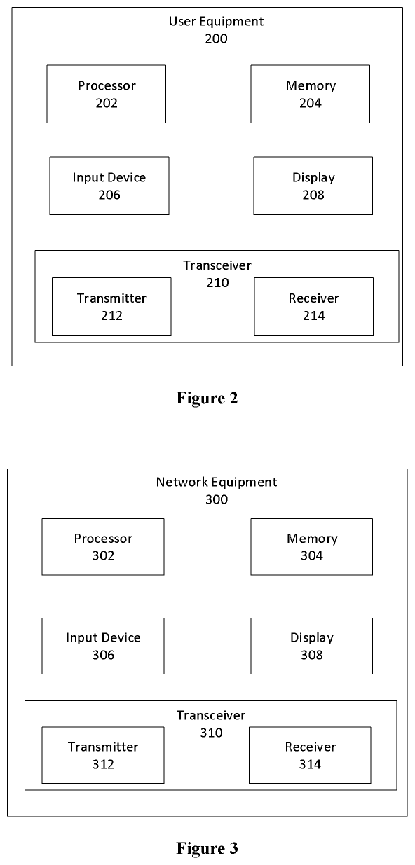

FIG. 2 is a schematic block diagram illustrating components of user equipment (UE) according to one embodiment. A UE 200 may include a processor 202, a memory 204, an input device 206, a display 208, and a transceiver 210. In some embodiments, the input device 206 and the display 208 are combined into a single device, such as a touchscreen. In certain embodiments, the UE 200 may not include any input device 206 and/or display 208. In various embodiments, the UE 200 may include one or more processors 202 and may not include the input device 206 and/or the display 208.

The processor 202, in one embodiment, may include any known controller capable of executing computer-readable instructions and/or capable of performing logical operations. For example, the processor 202 may be a microcontroller, a microprocessor, a central processing unit (CPU), a graphics processing unit (GPU), an auxiliary processing unit, a field programmable gate array (FPGA), or similar programmable controller. In some embodiments, the processor 202 executes instructions stored in the memory 204 to perform the methods and routines described herein. The processor 202 is communicatively coupled to the memory 204 and the transceiver 210.

The memory 204, in one embodiment, is a computer readable storage medium. In some embodiments, the memory 204 includes volatile computer storage media. For example, the memory 204 may include a RAM, including dynamic RAM (DRAM), synchronous dynamic RAM (SDRAM), and/or static RAM (SRAM). In some embodiments, the memory 204 includes non-volatile computer storage media. For example, the memory 204 may include a hard disk drive, a flash memory, or any other suitable non-volatile computer storage device. In some embodiments, the memory 204 includes both volatile and non-volatile computer storage media. In some embodiments, the memory 204 stores data relating to trigger conditions for transmitting the measurement report to the network equipment. In some embodiments, the memory 204 also stores program code and related data.

The input device 206, in one embodiment, may include any known computer input device including a touch panel, a button, a keyboard, a stylus, a microphone, or the like. In some embodiments, the input device 206 may be integrated with the display 208, for example, as a touchscreen or similar touch-sensitive display.

The display 208, in one embodiment, may include any known electronically controllable display or display device. The display 208 may be designed to output visual, audio, and/or haptic signals.

The transceiver 210, in one embodiment, is configured to communicate wirelessly with the network equipment. In certain embodiments, the transceiver 210 comprises a transmitter 212 and a receiver 214. The transmitter 212 is used to transmit UL communication signals to the network equipment and the receiver 214 is used to receive DL communication signals from the network equipment.

The transmitter 212 and the receiver 214 may be any suitable type of transmitters and receivers. Although only one transmitter 212 and one receiver 214 are illustrated, the transceiver 210 may have any suitable number of transmitters 212 and receivers 214. For example, in some embodiments, the UE 200 includes a plurality of the transmitter 212 and the receiver 214 pairs for communicating on a plurality of wireless networks and/or radio frequency bands, with each of the transmitter 212 and the receiver 214 pairs configured to communicate on a different wireless network and/or radio frequency band.

FIG. 3 is a schematic block diagram illustrating components of network equipment (NE) 300 according to one embodiment. The NE 300 may include a processor 302, a memory 304, an input device 306, a display 308, and a transceiver 310. As may be appreciated, the processor 302, the memory 304, the input device 306, the display 308, and the transceiver 310 may be similar to the processor 202, the memory 204, the input device 206, the display 208, and the transceiver 210 of the UE 200, respectively.

In some embodiments, the processor 302 controls the transceiver 310 to transmit DL signals or data to the UE 200. The processor 302 may also control the transceiver 310 to receive UL signals or data from the UE 200. In another example, the processor 302 may control the transceiver 310 to transmit DL signals containing various configuration data to the UE 200.

In some embodiments, the transceiver 310 comprises a transmitter 312 and a receiver 314. The transmitter 312 is used to transmit DL communication signals to the UE 200 and the receiver 314 is used to receive UL communication signals from the UE 200.

The transceiver 310 may communicate simultaneously with a plurality of UEs 200. For example, the transmitter 312 may transmit DL communication signals to the UE 200. As another example, the receiver 314 may simultaneously receive UL communication signals from the UE 200. The transmitter 312 and the receiver 314 may be any suitable type of transmitters and receivers. Although only one transmitter 312 and one receiver 314 are illustrated, the transceiver 310 may have any suitable number of transmitters 312 and receivers 314. For example, the NE 300 may serve multiple cells and/or cell sectors, where the transceiver 310 includes a transmitter 312 and a receiver 314 for each cell or cell sector.

This disclosure presents systems, apparatuses and methods for enhanced RAT-dependent integrity, as well as procedures to enable reliable and trustworthy Uu (uplink or downlink) positioning.

In the disclosure, designs of Integrity Alerts and Integrity Support are proposed through the use of explicit or implicit indication to provide actionable procedures when the positioning integrity either fulfils or does not fulfil the target integrity conditions as defined by the alert limit, protection level and time to alert. This addresses the sub-issue on how to indicate positioning assistance data for exclusion in order to avoid a loss in integrity. The design of the UE-based integrity reporting procedures to the location server to indicate positioning system unavailability is also proposed.

NR positioning based on NR Uu signals and Standalone (SA) architecture (e.g., beam-based transmissions) was first specified in Release 16. The targeted use cases also included commercial and regulatory (i.e., emergency services) scenarios as in Release 15. The performance requirements are provided in the following Table 1 [3GPP Technical Report TR 38.855]:

TABLE 1
Release 16 Positioning Performance Requirements

| Positioning Error | Indoor | Outdoor |
|---|---|---|
| Horizontal | <3 m for | <10 m for |
| Positioning | 80% of UEs | 80% of UEs |
| Vertical | <3 m for | <3 m for |
| Positioning | 80% of UEs | 80% of UEs |

Current 3GPP Release 17 has recently defined the positioning performance requirements for Commercial and IIoT use cases as follows, in Table 2 [3GPP Technical Report TR 38.857]:

TABLE 2
Release 17 Positioning Performance Requirements

| Positioning Error | Commercial | IIoT |
|---|---|---|
| Horizontal Positioning | (<1 m) for | (<0.2 m) for |
| | 90% of UEs | 90% of UEs; |
| Vertical Positioning | (<3 m) for | (<1 m) for |
| | 90% of UEs | 90% of UEs |
| Physical layer latency | (<10 ms) | (<10 ms) |
| for position estimation | | |
| of UE | | |
| End-to-End Latency | (<100 ms) | (<100 ms, in |
| for position estimation | | the order of 10 ms |
| of UE | | is desired) |

The supported positioning techniques in Release 16 are listed in Table 3 [3GPP Technical Specification TS 38.305]

TABLE 3
Supported UE Positioning Methods in Release 16

| | | UE- | NG-RAN | |
|---|---|---|---|---|
| | UE- | assisted, | node | |
| Method | based | LMF-based | assisted | SUPL |
| A-GNSS | Yes | Yes | No | Yes (UE-based and |
| | | | | UE-assisted) |
| OTDOA ^{Note1,} | No | Yes | No | Yes (UE-assisted) |
| ^{Note 2} | | | | |
| E-CID ^{Note 4} | No | Yes | Yes | Yes for E-UTRA |
| | | | | (UE-assisted) |
| Sensor | Yes | Yes | No | No |
| WLAN | Yes | Yes | No | Yes |
| Bluetooth | No | Yes | No | No |
| TBS ^{Note 5} | Yes | Yes | No | Yes (MBS) |
| DL-TDOA | Yes | Yes | No | No |
| DL-AoD | Yes | Yes | No | No |
| Multi-RTT | No | Yes | Yes | No |
| NR E-CID | No | Yes | FFS | No |
| UL-TDOA | No | No | Yes | No |
| UL-AoA | No | No | Yes | No |

^{NOTE1}
This includes TBS positioning based on PRS signals.
^{NOTE 2}
In this version of the specification only OTDOA based on LTE signals is supported.
^{NOTE 4}
This includes Cell-ID for NR method.
^{NOTE 5}
In this version of the specification only for TBS positioning based on MBS signals.

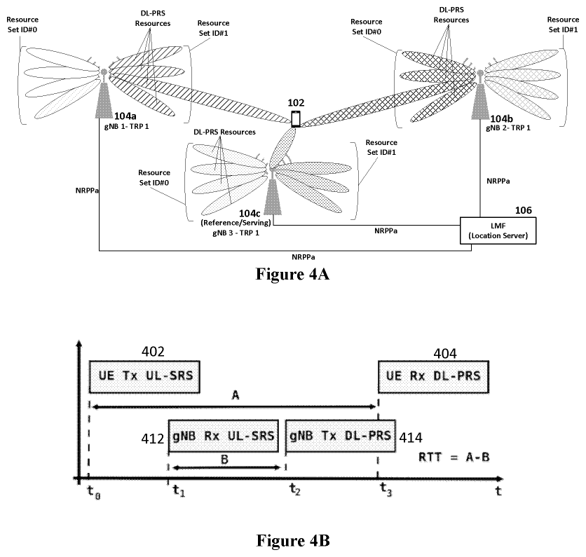

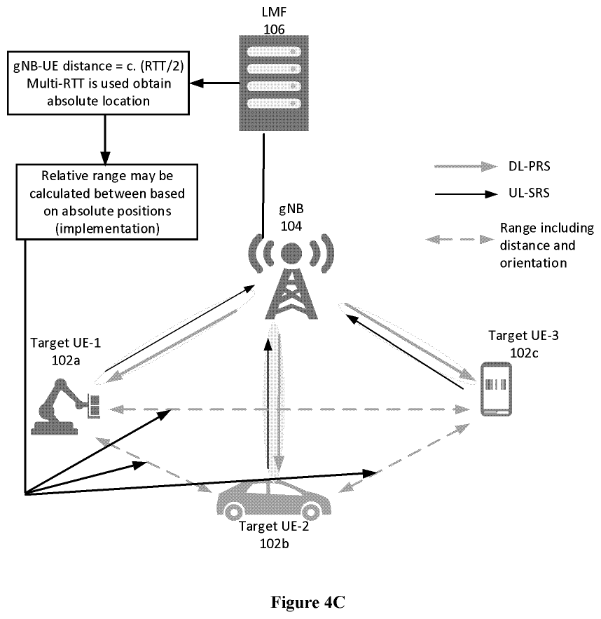

Separate positioning techniques as indicated in Table 3 may be dynamically configured and performed based on the requirements of the LMF and UE capabilities. The transmission of Uu (uplink and downlink) Positioning Reference Signals (PRS) enables a UE to perform UE positioning-related measurements or a gNB to perform gNB positioning-related measurements to enable the computation of the UE's absolute location estimate and is configured per Transmission Reception Point (TRP), where a TRP may include a set of one or more beams. A conceptual overview is illustrated in FIG. 4A, which is a schematic diagram illustrating an example of NR beam-based downlink positioning in accordance with some implementations of the present disclosure.

According to Release 16, the PRS (DL PRS) may be transmitted by different base stations (e.g., serving and neighboring base stations) using narrow beams over FR1 and FR2 as illustrated in FIG. 4A, which is relatively different compared to LTE where the PRS was transmitted across the whole cell.

In the example shown in FIG. 4A, the LMF 106 is in communication with three gNBs, each in turn communicates with the UE 102 through a respective TRP, i.e., TRP1 of gNB1 104a, TRP1 of gNB2 104b, and TRP1 or gNB3 104c. The PRS can be locally associated with a PRS Resource ID and Resource Set ID for a base station (gNB or TRP). Similarly, UE positioning measurements such as Reference Signal Time Difference (RSTD) and PRS RSRP measurements are made between beams (e.g., between a different pair of DL PRS resources or DL PRS resource sets) as opposed to different cells in the case of LTE. In addition, there are additional UL positioning methods for the network to exploit in order to compute the target UE's location. Table 4 and Table 5 below show the reference signal to measurements mapping required for each of the supported RAT-dependent positioning techniques at the UE and gNB, respectively. RAT-dependent positioning techniques involve the 3GPP RAT and core network entities to perform the position estimation of the UE, which are differentiated from RAT-independent positioning techniques which rely on GNSS, IMU sensor, WLAN and Bluetooth technologies for performing target device (i.e., UE) positioning.

TABLE 4
UE Measurements to Enable RAT-dependent
Positioning Techniques

| | | To facilitate support of the |
|---|---|---|
| DL/UL Reference | | following positioning |
| Signals | UE Measurements | techniques |
| Release 16 DL PRS | DL RSTD | DL-TDOA |
| Release 16 DL PRS | DL PRS RSRP | DL-TDOA, DL-AoD, |
| | | Multi-RTT |
| Release 16 DL PRS/ | UE Rx-Tx time | Multi-RTT |
| Release 16 SRS for | difference | |
| positioning | | |
| Release 15 SSB/ | SS-RSRP(RSRP for | E-CID |
| CSI-RS for RRM | RRM), SS-RSRQ(for | |
| | RRM), CSI-RSRP (for | |
| | RRM), CSI-RSRQ (for | |
| | RRM), SS-RSRPB | |
| | (for RRM) | |

TABLE 5
gNB Measurements to Enable RAT-
dependent Positioning Techniques

| | | To facilitate support |
|---|---|---|
| DL/UL Reference | | of the following |
| Signals | gNB Measurements | positioning techniques |
| Release 16 SRS for | UL RTOA | UL-TDOA |
| positioning | | |
| Release 16 SRS for | UL SRS-RSRP | UL-TDOA, UL-AoA, |
| positioning | | Multi-RTT |
| Release 16 SRS for | gNB Rx-Tx time | Multi-RTT |
| positioning, Release | difference | |
| 16 DL PRS | | |
| Release 16 SRS for | AoA and ZoA | UL-AoA, Multi-RTT |
| positioning, | | |

The following RAT-dependent positioning techniques are supported in Release 16 and Release 17 [3GPP Technical Specification TS 38.305]:

### DL-TDoA

The DL-TDOA positioning method makes use of the DL RSTD (and optionally DL PRS RSRP) of downlink signals received from multiple TPs, at the UE. The UE measures the DL RSTD (and optionally DL PRS RSRP) of the received signals using assistance data received from the positioning server, and the resulting measurements are used along with other configuration information to locate the UE in relation to the neighboring TPs.

### DL-AoD

The DL AoD positioning method makes use of the measured DL PRS RSRP of downlink signals received from multiple TPs, at the UE. The UE measures the DL PRS RSRP of the received signals using assistance data received from the positioning server, and the resulting measurements are used along with other configuration information to locate the UE in relation to the neighboring TPs.

### Multi-RTT

The Multi-RTT positioning method makes use of the UE Rx-Tx measurements and DL PRS RSRP of downlink signals received from multiple TRPs, measured by the UE and the measured gNB Rx-Tx measurements and UL SRS-RSRP at multiple TRPs of uplink signals transmitted from UE.
The UE measures the UE Rx-Tx measurements (and optionally DL PRS RSRP of the received signals) using assistance data received from the positioning server, and the TRPs measure the gNB Rx-Tx measurements (and optionally UL SRS-RSRP of the received signals) using assistance data received from the positioning server. The measurements are used to determine the RTT at the positioning server, which are used to estimate the location of the UE as shown in FIG. 4B.
FIG. 4B is a schematic diagram illustrating an example of Multi-cell RTT procedure in accordance with some implementations of the present disclosure. In this example, the Round Trip Time, RTT equals to =A−B, where A is the period from the starting of the transmission of UL-SRS 402 at the UE to the starting of the reception of DL-RPS 404 at the UE, and B is the period from the starting of reception of UL-SRS 412 at the gNB to the starting of the transmission of DL-PRS 414 at the gNB. It is noted that Multi-RTT is only supported for UE-assisted/NG-RAN assisted positioning techniques as shown in Table 3.
FIG. 4C is a schematic diagram illustrating an example of relative range estimation using the existing single gNB RTT positioning framework in accordance with some implementations of the present disclosure. FIG. 4C illustrates an implementation-based approach to compute the relative distance between two UEs. In FIG. 4C, the LMF 106 is in communication with the gNB 104, which communicates with three target UEs 102a, 102b, 102c. Multi-RTT is used to obtain the absolute locations of the UEs, and the relative range (i.e., the relative distance) between two UEs may be calculated based on absolute positions. This approach is high in latency and is not an efficient method in terms of procedures and signalling overhead.

### E-CID/NR E-CID

Enhanced Cell ID (CID) positioning method, the position of an UE is estimated with the knowledge of its serving ng-eNB, gNB and cell and is based on LTE signals. The information about the serving ng-eNB, gNB and cell may be obtained by paging, registration, or other methods. NR Enhanced Cell ID (NR E CID) positioning refers to techniques which use additional UE measurements and/or NR radio resource and other measurements to improve the UE location estimate using NR signals.
Although NR E-CID positioning may utilize some of the same measurements as the measurement control system in the RRC protocol, the UE generally is not expected to make additional measurements for the sole purpose of positioning; i.e., the positioning procedures do not supply a measurement configuration or measurement control message, and the UE reports the measurements that it has available rather than being required to take additional measurement actions.

### UL-TDoA

The UL TDOA positioning method makes use of the UL RTOA (and optionally UL SRS-RSRP) at multiple RPs of uplink signals transmitted from UE. The RPs measure the UL RTOA (and optionally UL SRS-RSRP) of the received signals using assistance data received from the positioning server, and the resulting measurements are used along with other configuration information to estimate the location of the UE.

### UL-AoA

The UL AoA positioning method makes use of the measured azimuth and the zenith of arrival at multiple RPs of uplink signals transmitted from UE. The RPs measure A-AoA and Z-AoA of the received signals using assistance data received from the positioning server, and the resulting measurements are used along with other configuration information to estimate the location of the UE.

The following RAT-independent positioning techniques are also supported in Release 16 and Release 17 [3GPP Technical Specification TS 38.305]:

### Network-Assisted GNSS Methods

These methods make use of UEs that are equipped with radio receivers capable of receiving GNSS signals. In 3GPP specifications the term GNSS encompasses both global and regional/augmentation navigation satellite systems.
Examples of global navigation satellite systems include GPS, Modernized GPS, Galileo, GLONASS, and BeiDou Navigation Satellite System (BDS). Regional navigation satellite systems include Quasi Zenith Satellite System (QZSS) while the many augmentation systems, are classified under the generic term of Space Based Augmentation Systems (SBAS) and provide regional augmentation services.
In this concept, different GNSSs (e.g., GPS, Galileo, etc.) can be used separately or in combination to determine the location of a UE.

### Barometric Pressure Sensor Positioning

The barometric pressure sensor method makes use of barometric sensors to determine the vertical component of the position of the UE. The UE measures barometric pressure, optionally aided by assistance data, to calculate the vertical component of its location or to send measurements to the positioning server for position calculation.
This method should be combined with other positioning methods to determine the 3D position of the UE.

### WLAN Positioning

The WLAN positioning method makes use of the WLAN measurements (AP identifiers and optionally other measurements) and databases to determine the location of the UE. The UE measures received signals from WLAN [1] access points, optionally aided by assistance data, to send measurements to the positioning server for position calculation. Using the measurement results and a references database, the location of the UE is calculated.
Alternatively, the UE makes use of WLAN measurements and optionally WLAN AP assistance data provided by the positioning server, to determine its location.

### Bluetooth Positioning

The Bluetooth positioning method makes use of Bluetooth measurements (beacon identifiers and optionally other measurements) to determine the location of the UE. The UE measures received signals from Bluetooth [2] beacons. Using the measurement results and a references database, the location of the UE is calculated. The Bluetooth methods may be combined with other positioning methods (e.g., WLAN) to improve positioning accuracy of the UE.

### TBS Positioning

A Terrestrial Beacon System (TBS) consists of a network of ground-based transmitters, broadcasting signals only for positioning purposes. The current type of TBS positioning signals are the MBS (Metropolitan Beacon System) signals [3] and Positioning Reference Signals (PRS) (TS 36.211 [4]). The UE measures received TBS signals, optionally aided by assistance data, to calculate its location or to send measurements to the positioning server for position calculation.

### Motion Sensor Positioning

The motion sensor method makes use of different sensors such as accelerometers, gyros, magnetometers, to calculate the displacement of UE. The UE estimates a relative displacement based upon a reference position and/or reference time. UE sends a report comprising the determined relative displacement which can be used to determine the absolute position. This method should be used with other positioning methods for hybrid positioning.

The different DL measurements including DL PRS-RSRP, DL RSTD and UE Rx-Tx time difference required for the supported RAT-dependent positioning techniques are shown in Table 6. The following measurement configurations are specified [3GPP Technical Specification TS 38.215]:
a) 4 Pair of DL RSTD measurements can be performed per pair of cells. Each measurement is performed between a different pair of DL PRS Resources/Resource Sets with a single reference timing.
b) 8 DL PRS RSRP measurements can be performed on different DL PRS resources from the same cell.

TABLE 6
DL Measurements required for DL-based positioning methods
DL PRS reference signal received power (DL PRS-RSRP)

| | |
|---|---|
| Definition | DL PRS reference signal received power (DL PRS-RSRP), is defined as the |
| | linear average over the power contributions (in [W]) of the resource elements |
| | that carry DL PRS reference signals configured for RSRP measurements |
| | within the considered measurement frequency bandwidth. |
| | For frequency range 1, the reference point for the DL PRS-RSRP shall be the |
| | antenna connector of the UE. For frequency range 2, DL PRS-RSRP shall be |
| | measured based on the combined signal from antenna elements |
| | corresponding to a given receiver branch. For frequency range 1 and 2, if |
| | receiver diversity is in use by the UE, the reported DL PRS-RSRP value shall |
| | not be lower than the corresponding DL PRS-RSRP of any of the individual |
| | receiver branches. |
| Applicable for | RRC_CONNECTED intra-frequency, |
| | RRC_CONNECTED inter-frequency |

DL reference signal time difference (DL RSTD)

| | |
|---|---|
| Definition | DL reference signal time difference (DL RSTD) is the DL relative timing |
| | difference between the positioning node j and the reference positioning node |
| | i, defined as T_{SubframeRxj} − T_{SubframeRxi}, |
| | Where: |
| | T_{SubframeRxj} is the time when the UE receives the start of one subframe from |
| | positioning node j. |
| | T_{SubframeRxi} is the time when the UE receives the corresponding start of one |
| | subframe from positioning node i that is closest in time to the subframe |
| | received from positioning node j. |
| | Multiple DL PRS resources can be used to determine the start of one |
| | subframe from a positioning node. |
| | For frequency range 1, the reference point for the DL RSTD shall be the |
| | antenna connector of the UE. For frequency range 2, the reference point for |
| | the DL RSTD shall be the antenna of the UE. |
| Applicable for | RRC_CONNECTED intra-frequency |
| | RRC_CONNECTED inter-frequency |

UE Rx − Tx time difference

| | |
|---|---|
| Definition | The UE Rx − Tx time difference is defined as T_{UE-RX} − T_{UE-TX} |
| | Where: |
| | T_{UE-RX} is the UE received timing of downlink subframe #i from a positioning |
| | node, defined by the first detected path in time. |
| | T_{UE-TX} is the UE transmit timing of uplink subframe #j that is closest in time to |
| | the subframe #i received from the positioning node. |
| | Multiple DL PRS resources can be used to determine the start of one |
| | subframe of the first arrival path of the positioning node. |
| | For frequency range 1, the reference point for T_{UE-RX} measurement shall be |
| | the Rx antenna connector of the UE and the reference point for T_{UE-TX} |
| | measurement shall be the Tx antenna connector of the UE. For frequency |
| | range 2, the reference point for T_{UE-RX} measurement shall be the Rx antenna |
| | of the UE and the reference point for T_{UE-TX} measurement shall be the Tx |
| | antenna of the UE. |
| Applicable for | RRC_CONNECTED intra-frequency |
| | RRC_CONNECTED inter-frequency |

DL PRS RSRPP (Reference Signal Received Path Power)

| | |
|---|---|
| Definition | DL PRS reference signal received path power (DL PRS-RSRPP), is defined |
| | as the power of the linear average of the channel response at the i-th path |
| | delay of the resource elements that carry DL PRS signal configured for the |
| | measurement, where DL PRS-RSRPP for the 1st path delay is the power |
| | contribution corresponding to the first detected path in time. |
| | For frequency range 1, the reference point for the DL PRS-RSRPP shall be |
| | the antenna connector of the UE. For frequency range 2, DL PRS-RSRPP |
| | shall be measured based on the combined signal from antenna elements |
| | corresponding to a given receiver branch. |
| Applicable for | RRC_CONNECTED, |
| | RRC_INACTIVE |

For convenience of description, in the disclosure, the following KPIs for positioning integrity are defined:

Target Integrity Risk (TIR): The probability that the positioning error exceeds the Alert Limit (AL) without warning the user within the required Time-to-Alert (TTA).

It may be noted that, conventionally, the TIR is usually defined as a probability rate per some time unit (e.g., per hour, per second or per independent sample).

Alert Limit (AL): The maximum allowable positioning error such that the positioning system is available for the intended application. If the positioning error is beyond the AL, the positioning system should be declared unavailable for the intended application to prevent loss of positioning integrity.

When the AL bounds the positioning error in the horizontal plane or on the vertical axis, then it is called Horizontal Alert Limit (HAL) or Vertical Alert Limit (VAL), respectively.

Time-to-Alert (TTA): The maximum allowable elapsed time from when the positioning error exceeds the Alert Limit (AL) until the function providing positioning integrity annunciates a corresponding alert.

Integrity Availability: The integrity availability is the percentage of time that the PL is below the required AL.

The Protection Level (PL) is a real-time upper bound on the positioning error at the required degree of confidence, where the degree of confidence is determined by the TIR probability.

The PL is a statistical upper-bound of the Positioning Error (PE) that ensures that, the probability per unit of time of the true error being greater than the AL and the PL being less than or equal to the AL, for longer than the TTA, is less than the required TIR, i.e., the PL satisfies the following inequality:

Prob per unit of time [((PE>AL) & (PL<=AL)) for longer than TTA]<required TIR

It may be noted that when the PL bounds the positioning error in the horizontal plane or on the vertical axis, then it is called Horizontal Protection Level (HPL) or Vertical Protection Level (VPL) respectively. A specific equation for the PL may not be specified as this is implementation-defined. For the PL to be considered valid, it must simply satisfy the inequality above.

The PL is used to indicate the positioning system availability, as when the PL is greater than the AL, the system is considered unavailable. The PL establishes a more rigorous upper bound on the positioning error by taking into consideration the additional feared events which have a lower occurrence (i.e., lower TIR) compared to the nominal events considered in the standard accuracy estimate alone. The lower the TIR, the more feared events need to be considered.

Fault feared events are those which are intrinsic to the positioning system and typically caused by the malfunction of an element of the positioning system (e.g., constellation or ground network failures). Fault-free feared events occur when the positioning system inputs are erroneous, but the event is not caused by a malfunction of the positioning system. In the GNSS context for example, fault-free feared events include nominal effects experienced every day such as poor satellite geometry, larger atmospheric gradients, and signal interruption, all of which can degrade positioning performance without causing the system to fail. A common limitation of existing industry functional safety standards is that only the fault conditions are considered. In practice, however, the fault-free conditions also have a material contribution to the total integrity risk budget and must therefore be monitored.

The PL is necessary to ensure all potential faults and fault-free events down to the required TIR are considered. It bounds the tails of the distribution with higher certainty (per unit of time) and provides a measure for ensuring only those positions whose positioning integrity has been validated within the TIR are included in the final positioning solution. By contrast, the standard accuracy estimate only considers a subset of feared events up to a nominal percentile (e.g., 2-sigma, 95%), based on the entire distribution of estimated position errors.

The TIR is a design constraint for a positioning system and represents the probability that a positioning error exceeds the AL, but the positioning system fails to alert the user within the required period of time (i.e., TTA). In practice, the TIR is very small. For example, <10⁻⁷/hr TIR translates to one failure permitted every 10 million hours (equivalent to 1142 years approximately).

Positioning integrity system failures are known as Integrity Events and integrity events occur when the positioning system outputs Hazardous Misleading Information (HMI). HMI occurs when, the positioning being declared available, the actual positioning error exceeds the AL without annunciating an alert within the required TTA. Misleading Information (MI) occurs when, the positioning system being declared available, the actual positioning error exceeds the PL. Typically, positioning systems are designed to tolerate some level of MI, provided the system can continue to operate safely within the AL. To properly monitor for integrity in the positioning system, both the fault and fault-free conditions which potentially lead to MI or HMI need to be characterized for the network and the UE.

The present disclosure provides solutions for enabling positioning integrity computation for RAT-dependent positioning methods, including:
a scheme of enabling procedures for providing RAT-dependent real-time integrity support for UEs in order to avoid a loss in positioning integrity through indications or adaptations of the DL-PRS/SRS resources within the positioning assistance data;
a scheme of providing a signalling framework to enable the transfer of RAT-dependent real-time integrity information and/or integrity service alerts based on a requested configuration; and
a scheme of transferring integrity results to the LMF for UE-based positioning integrity based on a reporting configuration.

Some examples or embodiments are described in detail for illustration of the schemes or methods. These examples or embodiments may be implemented separately, or in combination with each other, to support NR RAT-dependent positioning methods over the SL (PC5) interface.

In this disclosure, a positioning-related reference signal may be referred to as a reference signal used for positioning procedures or positioning purposes in order to estimate a target-UE's location, e.g., PRS, or utilizing existing reference signals such as CSI-RS or SRS; and a target-UE may be referred to as the device or entity to be localized or positioned. In various embodiments or examples, the term ‘PRS’ may refer to any signal such as a reference signal, which may or may not be used primarily for positioning.

In this disclosure, any reference made to position or location information may refer to either an absolute position, relative position with respect to another node or entity, ranging in terms of distance, ranging in terms of direction, or the combination thereof.

All contents of the PCT application of the same inventors, titled “METHODS AND APPARATUS OF DETERMINING INTEGRITY OF POSITIONING ESTIMATES” and filed on the same date as this patent application, are incorporated herein by reference in its entirety, and may be implemented in combination with the embodiments in this disclosure

### Real-Time Integrity Support for RAT-Dependent Positioning Methods

According to some examples, implementations, or embodiments, of the present disclosure, the procedures to support the signalling exchange of real-time positioning integrity parameters are proposed for the different RAT-dependent positioning techniques in order for the positioning calculation entity to be aware of the real-time integrity status. The real-time integrity information in the case of RAT-dependent positioning refers to a set of DL-PRS resources, DL-PRS resource sets, TRPs, which do not have to be measured in accordance with the integrity conditions. This information may be provided in an unsolicited or solicited manner, e.g., via a request from the UE. In other words, if the computed positioning integrity deems that a set of DL-PRS resources, DL-PRS resource sets, TRPs are not suitable for accurate measurement in order to satisfy the integrity conditions, then the UE may skip or ignore the resources for positioning measurement.

In an implementation, the integrity conditions may be defined by the following relationship:

P(RAT-dependent Error>Bound for longer than TTA|NOT DNU)<=Residual Risk+IRallocation (1)

where TTA is the elapse time for which the RAT-dependent positioning error may be higher than the Alert limit, before an alarm or warning message may be signalled to the positioning calculation entity, which may include the LMF (location server) for UE-assisted positioning methods, or in other implementations, the target-UE for UE-based positioning methods; DNU refers to “Do Not Use” flag; Residual Risk is the probability of Onset, which is defined per unit of time and represents the probability that the feared event occurs; and IRallocation is defined as a range of integrity risk defined by integrity risk lower and upper bounds in order to satisfy the relationship (1). The feared event is coupled with the anticipated positioning error exceeding a certain configured threshold and arising from a particular error source, which may vary depending on the error source and the applicable positioning technique. In some implementations, separate feared events may be defined for each RAT-dependent integrity error sources and may be signalled to the positioning calculation entity depending on the type of positioning model and associated integrity model. Two positioning integrity models are supported for the positioning integrity calculation including:
a) LMF-based Integrity, where the positioning integrity is computed at the LMF; and
b) UE-based Integrity, where the positioning integrity is computed at the target-UE.

In another implementation, the integrity conditions may be described as a function of the alert limit and protection level, where the alert limit is defined as the maximum allowable positioning error such that the positioning system is available for the intended application. If the positioning error is beyond the AL, the positioning system should be declared unavailable for the intended application to prevent loss in positioning integrity; and where the protection level is defined as the statistical upper-bound of the Positioning Error (PE) that ensures that, the probability per unit of time of the true error being greater than the AL and the PL being less than or equal to the AL, for longer than the TTA, is less than the required TIR, i.e., the PL satisfies the following inequality:

Prob per unit of time[((PE>AL) & (PL<=AL)) for longer than TTA]<required TIR (2)

### DL-PRS

According to one aspect, the location server (LMF) may also signal a message to the target-UE, informing which of the DL-PRS resources and associated granularity should not be measured since they would result in a loss in the positioning integrity. In some implementations, this may be based on an existing DL-PRS configuration at the UE, while in other implementations, it may be based on a preconfigured DL-PRS configuration (i.e., positioning assistance data). This message may be transmitted in response to a request sent by the target-UE for such information. In a further implementation, this message may also inform the target-UE that DL-PRS assistance data elements are not suitable for the positioning integrity computation or calculation. The LMF may signal the DL-PRS resources not to be measured in one or more of the following combinations in granularity including:
a) according to a specific DL positioning frequency layer (PFLs);
b) according to a specific TRP;
c) according to a specific DL-PRS resource set;
d) according to a specific DL-PRS resources; and/or
e) any combination of the above.

The above explicit exclusion of resources may be signalled to the UE using, e.g., UE-specific LPP signalling, e.g., using the RequestLocationInformation or ProvideAssistanceData message. In another implementation, the exclusion of resources to be measured may also be signalled using broadcast signalling, e.g., using a new or existing posSIB. According to the aforementioned implementation, the gNB or TRP may inform the LMF about the resources which are suitable or unsuitable for measurement, and the LMF may transmit the updated positioning assistance data to the gNB for broadcasting to multiple UEs, e.g., using a posSIB.

This may be a common DL-PRS configuration and/or may additionally include which of the resources can and/or cannot be used for measurement purposes and/or positioning integrity purposes, e.g., integrity calculation or computation. The DL-PRS resources to be excluded may also be signalled per positioning method, or in other implementations, be common across a plurality of positioning methods.

In another implementation, implicit signalling may be used by the LMF in order to enable the UE not to measure the affected DL-PRS resources, which may include:
a) Exclusion of the affected DL-PRS resources from the LPP ProvideAssistanceData message;
b) The UE may also transmit an indication to the LMF in the previous LPP message, e.g., using the LPP RequestAssistanceData message to indicate to the LMF about the provision of only suitable assistance data, e.g., for the purposes of integrity calculation; and thereafter the UE regards all received assistance data as available for integrity calculation, etc. This may reduce the unnecessary signalling transmission and associated overhead caused by providing assistance data that cannot be used;
c) The use of LMF-initiated on-demand DL-PRS to switch off TRPs or beams carrying DL-PRS resources for the purpose of real-time RAT-dependent integrity; and/or
d) The LMF may also choose to mute resources which are not required for integrity calculation, and the appropriate muting configuration, e.g., muting-option 1 or option 2, may be configured and signalled to the UE, e.g., via ProvideAssistanceData message:
   i. Muting option 1, which refers to the muting configuration applicable to the number of consecutive instances in which a DL-PRS resource set may be muted (i.e., muting DL-PRS repetitions).
   ii. Muting option 2, which refers to the muting configuration applicable to a bitmap of the time locations where the DL-PRS resource is transmitted (e.g., value ‘1’) or not (e.g., value ‘0’) within a single instance of a DL-PRS resource set.

In another implementation, the LMF may exclude certain DL-PRS resources to be measured according to previously received one or more UE measurement reports. These measurement reports may comprise DL RSTD, UE Rx-Tx time difference measurements, DL PRS RSRP, DL-PRS RSRPP measurements or the like. In a further implementation, the reports may be collected from multiple UEs and thereby a conclusion on whether the real-time RAT-dependent positioning integrity conditions are satisfied may be drawn from such a set of measurement reports.

In another implementation, the UE may trigger UE-initiated on-demand PRS to notify the LMF which DL-PRS resources according to various degrees of granularity may result in a loss in positioning integrity. This notification may be based on previous positioning measurements associated with the provided resources, where the positioning estimate and positioning integrity were computed and deemed not to satisfy the integrity conditions. The notification may be in the form of a list of DL-PRS resources, or in other implementations, a set of one or more DL-PRS resources, and may be signalled to the LMF using LPP signalling, e.g., ProvideAssistanceData message.

According to another aspect, a plurality of gNBs (including serving and neighbouring base stations) may provide a list of unsuitable DL-PRS resources to be measured in terms of positioning frequency layer, specific TRP, DL-PRS resource set, DL-PRS resources upon request. This may be signalled via NRPPa using the existing PRS Configuration Request and Response signalling.

The LMF may signal a real-time RAT-dependent RealTimeIntegrity message to the target-UE associated with each of the DL-PRS assistance data elements regarding which of the configured resources (including PFLs, TRPs, DL-PRS resource sets, DL-PRS resources) to avoid since they may result in a loss of integrity. In another implementation, this message may also inform the target-UE that DL-PRS assistance data elements are not suitable for the positioning integrity computation. Examples may include TRPs/Tx/Rx beams, which are deemed NLOS, and/or have a high degree of multipath, or high frequency of beam failure, UEs/devices which are on the cell-edge or experience poor connectivity and the like. The following is an exemplary signalling extract of a RAT-dependent RealTimeIntegrity message:

NR-RAT-dependent-RealTimeIntegrity

-- ASN1START
NR-DL-PRS-Bad-Assistance ::= SEQUENCE (SIZE (1..nrMaxFreqLayers)) OF

NR-DL-PRS-Bad-AssistancePerFreqLayer

NR-DL-PRS-Bad-AssistancePerFreqLayer ::=

SEQUENCE (SIZE (1..nrMaxTRPsPerFreq)) OF
NR-DL-PRS-Bad-AssistancePerTRP

NR-DL-PRS-Bad-AssistancePerTRP ::= SEQUENCE {

| dl-PRS-ID | INTEGER (0..255), | |
|---|---|---|
| nr-PhysCellID-r17 | NR-PhysCellID-r16 | OPTIONAL, -- Need ON |
| nr-CellGlobalID-r17 | NCGI-r15 | OPTIONAL, -- Need ON |
| nr-ARFCN-r17 | ARFCN-ValueNR-r15 | OPTIONAL, -- Need ON |

| DL-PRS-DNU | CHOICE { | |
|---|---|---|
| | perTrp | BOOLEAN DL-PRS-DNU Flag {True, False}, |
| | perResource | SEQUENCE (SIZE (1..nrMaxSetsPerTrpPerFreqLayer)) OF |

NR-DL-PRS-Bad-AssistancePerResource

```
  },
  ...
}
NR-DL-PRS-Bad-AssistancePerResource ::=
```

SEQUENCE (SIZE (1..nrMaxResourcesPerSet-r16)) OF

DL-PRS-DNU Flag

-- ASN1STOP

Description of the fields in the NR-RAT-dependent-RealTimeIntegrity is provided as follows in Table 7.

TABLE 7
NR-RAT-dependent-RealTimeIntegrity Field
NR-RAT-dependent-RealTimeIntegrity field descriptions

dl-PRS-ID
This field specifies the DL-PRS ID of the TRP for which the DNU
(Do Not Use) flag is provided.
nr-PhysCellID
This field specifies the physical Cell-ID of the TRP for which the
DNU flag is provided.
nr-CellGlobalID
This field specifies the NCGI, the globally unique identity of a
cell in NR, of the TRP.
nr-ARFCN
This field specifies the NR-ARFCN of the TRP's CD-SSB
(Cell-defining SSB)
DL-PRS-DNU
This field provides the whether the DNU applies to a TRP to the
target device (choice perTrp) or for all DL-PRS Resources of the
TRP (choice perResource).

In another implementation, a RAT-dependent RealTimeIntegrity message may be signalled per assistance data element of each positioning method, further indicating whether a particular positioning method may be associated with a “DNU”, i.e., the UE should avoid the use of a particular positioning method, e.g., DL-TDoA, NR E-CID, DL-AoD, or the combination thereof, since they may result in a loss in positioning integrity. In another implementation, this message may also inform the target-UE that DL-PRS assistance data elements are not suitable for the positioning integrity computation. The assistance data elements may also comprise one or more information elements (IEs).

### UL-PRS (SRS for Positioning and Normal SRS)

According to a further aspect, the location server (LMF) may also signal a message to the base station informing which of the UL-PRS including SRS for positioning resources and associated granularity should not be configured or measured, since they would result in a loss in positioning integrity. In another implementation, this message may also inform the target-UE that DL-PRS assistance data elements are not suitable for the positioning integrity computation. The LMF may signal the SRS for positioning resources not to be measured in one or more of the following combinations in granularity including:
a) according to a specific SRS carrier;
b) according to a specific UL BWP of carrier;
c) according to a specific SRS resource set;
d) according to a specific SRS resources; and/or
e) any combination of the above.

The above SRS may be applicable to SRS for positioning or other normal SRS resources used for purposes other than positioning.

The above explicit exclusion of resources may be signalled to the serving and/or neighbouring base stations (e.g., gNB, NG-RAN nodes) using, e.g., NRPPa signalling, such as the Positioning Information Request and Response messages. In another implementation, the exclusion of SRS resources to be measured may also be signalled using the NRPPa, such as a pair of messages Measurement Request and Response.

In another implementation, implicit signalling may be used by the LMF in order to enable the gNB not to measure the affected SRS resources, which may include: exclusion of the affected SRS resources when requesting a desired SRS configuration using the NRPPa Positioning Information Request message.

In an extended implementation, the LMF may also transmit an indication to NG-RAN node, e.g., gNB or TRP, in the previous NRPPa message, e.g., using NRPPa Positioning Information Request to indicate to the LMF about the provision of only suitable SRS configurations, e.g., for the purposes of integrity calculation; and thereafter the LMF regards all received SRS configurations from the gNB or TRP as available for integrity calculation, etc. This may reduce the unnecessary signalling transmission and associated overhead caused by providing SRS configurations that cannot be used for positioning integrity purposes, e.g., integrity calculations.

In another implementation, the LMF may exclude certain SRS resources to be measured according to previously received one or more NG-RAN/gNB measurement reports. These measurement reports may comprise UL RTOA, UL AoA, UL SRS RSRP, SRS RSRPP measurements or the like. In a further implementation, the reports may be collected from multiple gNBs and thereby a conclusion on whether the real-time RAT-dependent positioning integrity conditions are satisfied may be drawn from such a set of measurement reports.

According to a further aspect, a plurality of gNBs (including serving and neighbouring base stations) may provide a list of unsuitable SRS resources to be measured in terms of SRS carrier, UL BWP, SRS resource set, SRS resources upon request. This may be signalled, e.g., via NRPPa using the existing Positioning Information Update procedure or Positioning Information Response procedure.

The LMF may signal a real-time RAT-dependent RealTimeIntegrity message to the gNBs associated with each of the SRS resources regarding which of the configured resources (including carrier, UL BWP, SRS resource sets, SRS resources) to avoid since they may result in a loss in positioning integrity. Examples may include TRPs/Tx/Rx beams, which are deemed NLOS, and/or have a high degree of multipath, or high frequency of beam failure, UEs/devices which are on the cell-edge or experience poor connectivity and the like.

According to this aspect, the location server (LMF) may first determine if the UE has the required capability to exchange or transfer real-time integrity and/or integrity service alert related information for RAT-dependent positioning methods, or the combination thereof. The location server may use this capability information to trigger and initiate the request for certain DL-PRS and/or SRS resources, including SRS for positioning and MIMO SRS not to be measured. In other cases, this may be used to indicate that certain assistance data elements are not used. The LMF may use LPP signalling, such as RequestCapabilityInformation, to request the UE for real-time integrity and/or integrity service alert related information; and the UE may use LPP ProvideCapabilityInformation to transmit the response of the aforementioned capabilities.

### Integrity Service Alerts

According to one aspect of some examples, implementations, or embodiments, of the present disclosure, in the case of LMF-based and UE-based positioning integrity, the LMF may explicitly or implicitly configure the UE not to use the positioning assistance data elements that may result in a loss in positioning integrity. An explicit configuration may involve the use of the “Do Not Use” flag, which may be associated with assistance data elements, such as TRP location, DL-PRS resources, DL-PRS resource sets, TRPs, and/or positioning frequency layers. In other implementations, an implicit configuration may involve the omission of such assistance data elements from assistance data message to the UE, e.g., omission of the relevant IEs from the LPP ProvideAssistanceData message. applicable for assistance data related to UE-based and UE-assisted positioning methods.

According to one aspect, the issued DNU flags for one or more assistance data elements may be associated with a validity duration, which may be signalled from the LMF. The validity duration may be signalled in time units of milliseconds, seconds, minutes, hours and so forth. In another implementation, the DNU validity may be based on an event, e.g., the UE leaves a particular cell or area, enters or leaves a validity area. In another implementation, the DNU validity may align with the posSIB expiration time, or in some other implementations, a separate DNU validity may not be configured and will be equivalent to the posSIB expiration time.

According to one aspect, the issued DNU flags may be applicable to pre-configured positioning assistance data, if configured. The DNU may also extend to validity areas, which may result in a loss of positioning or not be considered for the integrity computations.

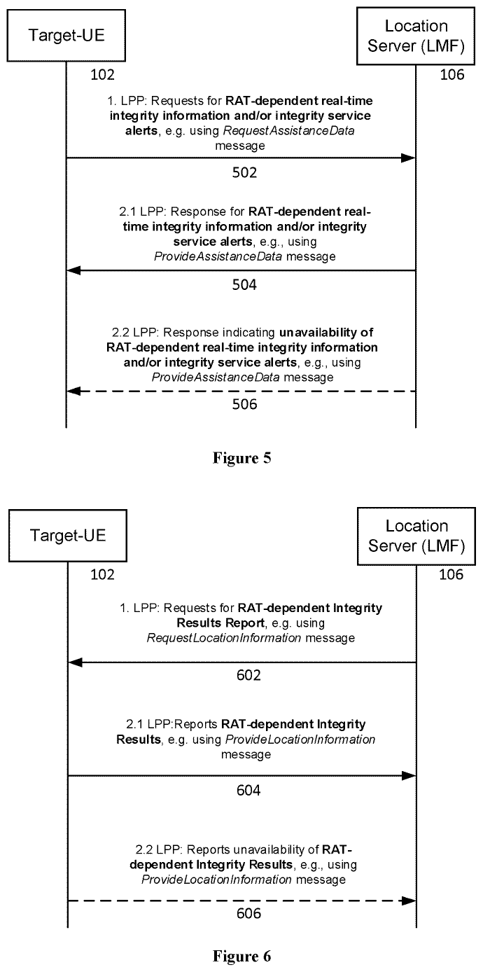

According to a further aspect, the UE may request for the positioning integrity service alerts and real-time integrity information for the purposes of UE-based positioning integrity. FIG. 5 is a schematic diagram illustrating an example of enabling indication of integrity and/or integrity service alerts for UE-based positioning integrity via request/response signalling with LMF in accordance with some implementations of the present disclosure.

In the exemplary illustration of the signalling flow shown in FIG. 5, the steps for enabling the indication of integrity and/or integrity service alerts with the LMF are detailed as follows.

The target-UE 102 transmits a request for integrity and/or integrity service alerts using LPP signalling, e.g., using LPP RequestAssistanceData message 502.

The LMF 106 may initially determine whether the target UE 102 is capable of receiving such alert message based on a prior capability exchange with the LMF 106. The request may additionally include the following indications:
a) To provide the integrity and/or integrity service alerts per positioning method, e.g., DL-TDoA, Multi-RTT, DL-AoD, etc.
b) To provide the integrity and/or integrity service alerts common to all positioning methods, e.g., DL-TDoA, Multi-RTT, DL-AoD, etc.
c) To provide a frequency indication of how often the integrity and/or integrity service alerts are to be provided, e.g., aperiodic, one shot, periodic, periodic based on activation/deactivation command and so forth; or
d) Any one or more combinations of the above.

The LMF 106 may positively or negatively respond to the target UE 102 depending on the availability of the requested integrity and/or integrity service alerts.

The LMF 106 may respond with the requested information, e.g., RAT-dependent integrity information and/or integrity service alerts, according to the different described implementations, using LPP ProvideAssistanceData message 504, if the information is available. The LMF 106 may provide an explicit DNU flag and associated timer for each of the assistance data elements including Inter-TRP synchronization (RTD-info IE), TRP location (NR-TRP-LocationInfo IE), DL-PRS Beam Information (NR-DL-PRS-BeamInfo IE), DL-PRS Beam Antenna Information (NR-TRP-BeamAntennaInfo IE) and so forth. In another implementation, the LMF 106 may simply exclude the described positioning assistance data elements, implying that the excluded assistance data elements are not to be considered for integrity calculation. In such cases, the LMF 106 is to provide a new replacement assistance data IE in order to allow the UE to compute its own position.

In the event that the integrity and/or integrity service alerts are unavailable, the LMF 106 may indicate the unavailability of integrity, integrity service alerts, or the combination thereof, using LPP ProvideAssistanceData message 506. In another implementation, the LMF 106 may simply choose to ignore the UE's request for integrity and/or integrity service alerts. In this implementation, the lack of such information may affect the positioning integrity and may result in a loss in positioning integrity.

In some examples, the PRS may be a Downlink (DL)-PRS, Sounding Reference Signal (SRS) for positioning, and/or Multiple Input Multiple Output (MIMO) SRS. The request message may comprise an indication that the RAT-dependent positioning integrity information and/or integrity service alert information is common to all positioning methods. The indication of frequency may comprise an indication of: aperiodic, one shot, periodic, and/or periodic based on activation/deactivation command. The response message is transmitted using a Long Term Evolution Positioning Protocol (LPP) User Equipment (UE)-specific signalling or a broadcast signalling.

The unsuitable PRS may be a DL PRS; and the DL PRS is indicated in the response message according to resource granularities of: positioning frequency layer, transmission reception point (TRP), DL-PRS resource set, and/or DL-PRS resource. The unsuitable PRS may be associated with pre-configured assistance data. In some examples, the unsuitable PRS is indicated explicitly with a Do Not Use (DNU) flag; and the Do Not Use (DNU) flag is configured with associated validity criteria, and the validity criteria comprise a validity duration, and/or a validity area. In some other examples, the unsuitable PRS is indicated implicitly with the unsuitable PRS excluded from the positioning assistance data message or based on a previously transmitted positioning assistance data message; and/or the unsuitable PRS is indicated implicitly, by switching off TRPs or beams carrying DL-PRS resources or muting the DL-PRS resources.

### Integrity Result Reporting

According to one aspect of some examples, implementations, or embodiments, of the present disclosure, the UE may also report the integrity results to the LMF, or the LMF may report the integrity results to an external LCS Client.

According to one implementation, in the case of UE-based positioning integrity, the UE may report a plurality of parameters related to the RAT-dependent positioning integrity calculation to the LMF including the following:
a) Protection Level (PL), that
   i. may be applicable to horizontal and/or vertical protection level (in meters),
   ii. may be applicable to direction or bearing or heading (in degrees or radians), and/or
   iii. may be applicable to speed or velocity (in m/s);
b) Alert Limit (AL); and/or
c) Time to Alert (TTA).

The aforementioned integrity parameters may be reported to the LMF along with the positioning estimate using LPP signalling, e.g., ProvideLocationInformation message. FIG. 6 is a schematic diagram illustrating an example of enabling integrity result reporting for UE-based positioning integrity in accordance with some implementations of the present disclosure.

In the exemplary illustration of the reporting procedure as shown in FIG. 6, in which the integrity result reporting is requested by the LMF, the steps for enabling the reporting of the integrity results with the LMF for UE-based positioning integrity are detailed as follows.

The LMF 106 transmits a request for Integrity Results reporting e.g., using LPP signalling, such as LPP RequestLocationInformation message 602. The LMF 106 may initially determine whether the target UE 102 is capable of reporting RAT-dependent integrity results based on a prior capability exchange with the LMF 106.

The request for RAT-dependent integrity results report may additionally include:
a) A plurality of RAT-dependent integrity information parameters including TIR, AL, PL, TTA or the combination thereof,
b) Indication to provide a frequency indication of how often the RAT-dependent integrity results are to be reported, e.g., aperiodic, one shot, periodic, periodic based on activation/deactivation command and so forth;
c) Indication on whether the positioning service is unavailable;
d) Indication on the duration that a positioning service is unavailable or not using a flag, e.g., Boolean values, binary values, etc.;
e) Indication on whether there is a loss in positioning integrity;
f) Indication on the reporting mode, e.g., integrity Mode 1 or Mode 2 reporting operations; or
g) Any one or more combinations of the above.

The target UE 102 may positively or negatively respond to the LMF 106 depending on the availability of the requested RAT-dependent integrity information parameters.

The UE 102 may respond with the requested information, e.g., RAT-dependent integrity results report using, e.g., LPP ProvideLocationInformation message 604, in addition to the provided location estimate.

In the event that the integrity results are unavailable, the UE 102 may indicate the unavailability of such results using, e.g., LPP ProvideLocationInformation message 606. In other implementations, an error cause may be associated with such an indication, in order to provide a reason (or cause) as to why the integrity results are unavailable.

According to another aspect, the integrity results may be reported based on reporting mode of operation, e.g., integrity Mode 1 or Mode 2 reporting operations.

In the above examples, the transmitter of the LMF 106 further transmits to the UE 102 an integrity result request for reporting of the RAT-dependent positioning integrity information. The RAT dependent positioning integrity information may comprise: Target Integrity Risk (TIR), Alert Limit (AL), Protection Level (PL), Time to Alert (TTA), availability of positioning service, and/or an indication of whether there is loss of integrity. The integrity result request may comprise an indication of frequency for reporting of the RAT-dependent positioning integrity information, comprising aperiodic, one shot, periodic or periodic based on activation and/or deactivation command. The receiver of the LMF 106 may receive from the UE 102 a report of RAT dependent positioning integrity information.

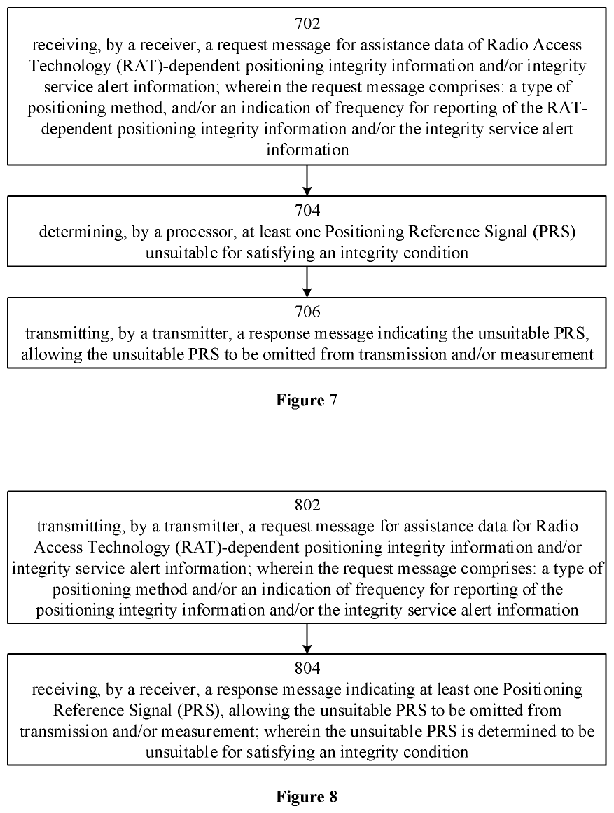

FIG. 7 is a flow chart illustrating steps of positioning integrity computation by LMF in accordance with some implementations of the present disclosure.

At step 702, the receiver of the LMF receives a request message for assistance data of Radio Access Technology (RAT)-dependent positioning integrity information and/or integrity service alert information; wherein the request message comprises: a type of positioning method, and/or an indication of frequency for reporting of the RAT-dependent positioning integrity information and/or the integrity service alert information.

At step 704, the processor of the LMF determines at least one Positioning Reference Signal (PRS) unsuitable for satisfying an integrity condition.

At step 706, the transmitter of the LMF transmits a response message indicating the unsuitable PRS, allowing the unsuitable PRS to be omitted from transmission and/or measurement.

FIG. 8 is a flow chart illustrating steps of positioning integrity computation by UE in accordance with some implementations of the present disclosure.

At step 802, the transmitter 212 of the UE 200 transmits a request message for assistance data for Radio Access Technology (RAT)-dependent positioning integrity information and/or integrity service alert information; wherein the request message comprises: a type of positioning method and/or an indication of frequency for reporting of the positioning integrity information and/or the integrity service alert information.

At step 804, the receiver 214 of the UE 200 receives a response message indicating at least one Positioning Reference Signal (PRS), allowing the unsuitable PRS to be omitted from transmission and/or measurement; wherein the unsuitable PRS is determined to be unsuitable for satisfying an integrity condition.

In one aspect, some items as examples of the disclosure concerning UE may be summarized as follows:
1. An apparatus, comprising:
a receiver that receives a request message for assistance data of Radio Access Technology (RAT)-dependent positioning integrity information and/or integrity service alert information; wherein the request message comprises: a type of positioning method, and/or an indication of frequency for reporting of the RAT-dependent positioning integrity information and/or the integrity service alert information;
a processor that determines at least one Positioning Reference Signal (PRS) unsuitable for satisfying an integrity condition; and
a transmitter that transmits a response message indicating the unsuitable PRS, allowing the unsuitable PRS to be omitted from transmission and/or measurement.
2. The apparatus according to item 1, wherein the PRS comprises: Downlink (DL)-PRS, Sounding Reference Signal (SRS) for positioning, and/or Multiple Input Multiple Output (MIMO) SRS.
3. The apparatus according to item 1, wherein the request message comprises an indication that the RAT-dependent positioning integrity information and/or integrity service alert information is common to all positioning methods.
4. The apparatus according to item 1, wherein the indication of frequency comprises an indication of: aperiodic, one shot, periodic, and/or periodic based on activation/deactivation command.
5. The apparatus according to item 1, wherein the integrity condition is defined according to: Probability per unit of time [((Positioning Error>Alert Limit) & (Protection Level<=Alert Limit)) for longer than Time to Alert]<required Target Integrity Risk.
6. The apparatus according to item 1, wherein the response message is transmitted using a Long Term Evolution Positioning Protocol (LPP) User Equipment (UE)-specific signalling or a broadcast signalling.
7. The apparatus according to item 1, wherein the unsuitable PRS is a DL PRS; and the DL PRS is indicated in the response message according to resource granularities of: positioning frequency layer, transmission reception point (TRP), DL-PRS resource set, and/or DL-PRS resource.
8. The apparatus according to item 7, wherein the unsuitable PRS is indicated explicitly with a Do Not Use (DNU) flag.
9. The apparatus according to item 8, wherein the Do Not Use (DNU) flag is configured with associated validity criteria, and the validity criteria comprise a validity duration, and/or a validity area.
10. The apparatus according to item 7, wherein the unsuitable PRS is indicated implicitly with the unsuitable PRS excluded from the positioning assistance data message or based on a previously transmitted positioning assistance data message.
11. The apparatus according to item 7, wherein the unsuitable PRS is indicated implicitly, by switching off TRPs or beams carrying DL-PRS resources or muting the DL-PRS resources.
12. The apparatus according to item 7, wherein the unsuitable PRS is associated with pre-configured assistance data.
13. The apparatus according to item 1, wherein the transmitter further transmits an integrity result request for reporting of the RAT-dependent positioning integrity information.
14. The apparatus according to item 13, wherein the RAT dependent positioning integrity information comprises: Target Integrity Risk (TIR), Alert Limit (AL), Protection Level (PL), Time to Alert (TTA), availability of positioning service, and/or an indication of whether there is loss of integrity.
15. The apparatus according to item 13, wherein the integrity result request comprises an indication of frequency for reporting of the RAT-dependent positioning integrity information, comprising aperiodic, one shot, periodic or periodic based on activation and/or deactivation command.
16. The apparatus according to item 15, wherein the receiver further receives a report of RAT dependent positioning integrity information.

In another aspect, some items as examples of the disclosure concerning gNB may be summarized as follows:
17. An apparatus, comprising:
a transmitter that transmits a request message for assistance data for Radio Access Technology (RAT)-dependent positioning integrity information and/or integrity service alert information; wherein the request message comprises: a type of positioning method and/or an indication of frequency for reporting of the positioning integrity information and/or the integrity service alert information; and
a receiver that receives a response message indicating at least one Positioning Reference Signal (PRS), allowing the unsuitable PRS to be omitted from transmission and/or measurement; wherein the unsuitable PRS is determined to be unsuitable for satisfying an integrity condition.
18. The apparatus according to item 17, wherein the PRS comprises: Downlink (DL)-PRS, Sounding Reference Signal (SRS) for positioning, and/or Multiple Input Multiple Output (MIMO) SRS.
19. The apparatus according to item 17, wherein the request message comprises an indication that the RAT-dependent positioning integrity information and/or integrity service alert information is common to all positioning methods.
20. The apparatus according to item 17, wherein the indication of frequency comprises an indication of: aperiodic, one shot, periodic, and/or periodic based on activation/deactivation command.
21. The apparatus according to item 17, wherein the integrity condition is defined according to: Probability per unit of time [((Positioning Error>Alert Limit) & (Protection Level<=Alert Limit)) for longer than Time to Alert]<required Target Integrity Risk.
22. The apparatus according to item 17, wherein the response message is transmitted using a Long Term Evolution Positioning Protocol (LPP) User Equipment (UE)-specific signalling or a broadcast signalling.
23. The apparatus according to item 17, wherein the unsuitable PRS is a DL PRS; and the DL PRS is indicated in the response message according to resource granularities of: positioning frequency layer, transmission reception point (TRP), DL-PRS resource set, and/or DL-PRS resource.
24. The apparatus according to item 23, wherein the unsuitable PRS is indicated explicitly with a Do Not Use (DNU) flag.
25. The apparatus according to item 24, wherein the Do Not Use (DNU) flag is configured with associated validity criteria, and the validity criteria comprise a validity duration, and/or a validity area.
26. The apparatus according to item 23, wherein the unsuitable PRS is indicated implicitly with the unsuitable PRS excluded from the positioning assistance data message or based on a previously transmitted positioning assistance data message.
27. The apparatus according to item 23, wherein the unsuitable PRS is indicated implicitly, by switching off TRPs or beams carrying DL-PRS resources or muting the DL-PRS resources.
28. The apparatus according to item 23, wherein the unsuitable PRS is associated with pre-configured assistance data.
29. The apparatus according to item 17, wherein the receiver further receives an integrity result request for reporting of the RAT-dependent positioning integrity information.
30. The apparatus according to item 29, wherein the RAT dependent positioning integrity information comprises: Target Integrity Risk (TIR), Alert Limit (AL), Protection Level (PL), Time to Alert (TTA), availability of positioning service, and/or an indication of whether there is loss of integrity.
31. The apparatus according to item 29, wherein the integrity result request comprises an indication of frequency for reporting of the RAT-dependent positioning integrity information, comprising aperiodic, one shot, periodic or periodic based on activation and/or deactivation command.
32. The apparatus according to item 31, wherein the transmitter further transmits a report of RAT dependent positioning integrity information.

In a further aspect, some items as examples of the disclosure concerning a method of UE may be summarized as follows:
33. A method, comprising:
receiving, by a receiver, a request message for assistance data of Radio Access Technology (RAT)-dependent positioning integrity information and/or integrity service alert information; wherein the request message comprises: a type of positioning method, and/or an indication of frequency for reporting of the RAT-dependent positioning integrity information and/or the integrity service alert information;
determining, by a processor, at least one Positioning Reference Signal (PRS) unsuitable for satisfying an integrity condition; and
transmitting, by a transmitter, a response message indicating the unsuitable PRS, allowing the unsuitable PRS to be omitted from transmission and/or measurement.
34. The method according to item 33, wherein the PRS comprises: Downlink (DL)-PRS, Sounding Reference Signal (SRS) for positioning, and/or Multiple Input Multiple Output (MIMO) SRS.
35. The method according to item 33, wherein the request message comprises an indication that the RAT-dependent positioning integrity information and/or integrity service alert information is common to all positioning methods.
36. The method according to item 33, wherein the indication of frequency comprises an indication of: aperiodic, one shot, periodic, and/or periodic based on activation/deactivation command.
37. The method according to item 33, wherein the integrity condition is defined according to: Probability per unit of time [((Positioning Error>Alert Limit) & (Protection Level<=Alert Limit)) for longer than Time to Alert]<required Target Integrity Risk.
38. The method according to item 33, wherein the response message is transmitted using a Long Term Evolution Positioning Protocol (LPP) User Equipment (UE)-specific signalling or a broadcast signalling.
39. The method according to item 33, wherein the unsuitable PRS is a DL PRS; and the DL PRS is indicated in the response message according to resource granularities of: positioning frequency layer, transmission reception point (TRP), DL-PRS resource set, and/or DL-PRS resource.
40. The method according to item 39, wherein the unsuitable PRS is indicated explicitly with a Do Not Use (DNU) flag.
41. The method according to item 40, wherein the Do Not Use (DNU) flag is configured with associated validity criteria, and the validity criteria comprise a validity duration, and/or a validity area.
42. The method according to item 39, wherein the unsuitable PRS is indicated implicitly with the unsuitable PRS excluded from the positioning assistance data message or based on a previously transmitted positioning assistance data message.
43. The method according to item 39, wherein the unsuitable PRS is indicated implicitly, by switching off TRPs or beams carrying DL-PRS resources or muting the DL-PRS resources.
44. The method according to item 39, wherein the unsuitable PRS is associated with pre-configured assistance data.
45. The method according to item 33, wherein the transmitter further transmits an integrity result request for reporting of the RAT-dependent positioning integrity information.
46. The method according to item 45, wherein the RAT dependent positioning integrity information comprises: Target Integrity Risk (TIR), Alert Limit (AL), Protection Level (PL), Time to Alert (TTA), availability of positioning service, and/or an indication of whether there is loss of integrity.
47. The method according to item 45, wherein the integrity result request comprises an indication of frequency for reporting of the RAT-dependent positioning integrity information, comprising aperiodic, one shot, periodic or periodic based on activation and/or deactivation command.
48. The method according to item 47, wherein the receiver further receives a report of RAT dependent positioning integrity information.

In a yet further aspect, some items as examples of the disclosure concerning a method of gNB may be summarized as follows:
49. A method, comprising:
transmitting, by a transmitter, a request message for assistance data for Radio Access Technology (RAT)-dependent positioning integrity information and/or integrity service alert information; wherein the request message comprises: a type of positioning method and/or an indication of frequency for reporting of the positioning integrity information and/or the integrity service alert information; and
receiving, by a receiver, a response message indicating at least one Positioning Reference Signal (PRS), allowing the unsuitable PRS to be omitted from transmission and/or measurement; wherein the unsuitable PRS is determined to be unsuitable for satisfying an integrity condition.
50. The method according to item 49, wherein the PRS comprises: Downlink (DL)-PRS, Sounding Reference Signal (SRS) for positioning, and/or Multiple Input Multiple Output (MIMO) SRS.
51. The method according to item 49, wherein the request message comprises an indication that the RAT-dependent positioning integrity information and/or integrity service alert information is common to all positioning methods.
52. The method according to item 49, wherein the indication of frequency comprises an indication of: aperiodic, one shot, periodic, and/or periodic based on activation/deactivation command.
53. The method according to item 49, wherein the integrity condition is defined according to: Probability per unit of time [((Positioning Error>Alert Limit) & (Protection Level<=Alert Limit)) for longer than Time to Alert]<required Target Integrity Risk.
54. The method according to item 49, wherein the response message is transmitted using a Long Term Evolution Positioning Protocol (LPP) User Equipment (UE)-specific signalling or a broadcast signalling.
55. The method according to item 49, wherein the unsuitable PRS is a DL PRS; and the DL PRS is indicated in the response message according to resource granularities of: positioning frequency layer, transmission reception point (TRP), DL-PRS resource set, and/or DL-PRS resource.
56. The method according to item 55, wherein the unsuitable PRS is indicated explicitly with a Do Not Use (DNU) flag.
57. The method according to item 56, wherein the Do Not Use (DNU) flag is configured with associated validity criteria, and the validity criteria comprise a validity duration, and/or a validity area.
58. The method according to item 55, wherein the unsuitable PRS is indicated implicitly with the unsuitable PRS excluded from the positioning assistance data message or based on a previously transmitted positioning assistance data message.
59. The method according to item 55, wherein the unsuitable PRS is indicated implicitly, by switching off TRPs or beams carrying DL-PRS resources or muting the DL-PRS resources.
60. The method according to item 55, wherein the unsuitable PRS is associated with pre-configured assistance data.
61. The method according to item 49, wherein the receiver further receives an integrity result request for reporting of the RAT-dependent positioning integrity information.
62. The method according to item 61, wherein the RAT dependent positioning integrity information comprises: Target Integrity Risk (TIR), Alert Limit (AL), Protection Level (PL), Time to Alert (TTA), availability of positioning service, and/or an indication of whether there is loss of integrity.
63. The method according to item 61, wherein the integrity result request comprises an indication of frequency for reporting of the RAT-dependent positioning integrity information, comprising aperiodic, one shot, periodic or periodic based on activation and/or deactivation command.
64. The method according to item 63, wherein the transmitter further transmits a report of RAT dependent positioning integrity information.

Various embodiments and/or examples are disclosed to provide exemplary and explanatory information to enable a person of ordinary skill in the art to put the disclosure into practice. Features or components disclosed with reference to one embodiment or example are also applicable to all embodiments or examples unless specifically indicated otherwise.

Embodiments may be practiced in other specific forms. The described embodiments are to be considered in all respects only as illustrative and not restrictive. The scope is, therefore, indicated by the appended claims rather than by the foregoing description. All changes which come within the meaning and range of equivalency of the claims are to be embraced within their scope.

What is claimed is:

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. An apparatus for wireless communication, comprising:
at least one memory; and
at least one processor coupled with the at least one memory and operable to cause the apparatus to:
receive a request message for assistance data of one or more of radio access technology (RAT)-dependent positioning integrity information or integrity service alert information, wherein the request message comprises one or more of a type of positioning method an indication of frequency for reporting of the one or more of the RAT-dependent positioning integrity information or the integrity service alert information;
determine at least one positioning reference signal (PRS) unsuitable for satisfying an integrity condition; and
transmit a response message indicating the unsuitable PRS.

17. The apparatus of claim 16, wherein the unsuitable PRS comprises one or more of downlink (DL)-PRS, sounding reference signal (SRS) for positioning, or multiple input multiple output (MIMO) SRS.

18. The apparatus of claim 16, wherein the request message comprises an indication that the one or more of the RAT-dependent positioning integrity information or the integrity service alert information is common to multiple positioning methods.

19. The apparatus of claim 16, wherein the indication of frequency comprises an indication of one or more of aperiodic, one shot, periodic, or periodic based on one or more of an activation command or a deactivation command.

20. The apparatus of claim 16, wherein the response message is transmitted using a long term evolution positioning protocol (LPP) user equipment (UE)-specific signaling or a broadcast signaling.

21. The apparatus of claim 16, wherein the unsuitable PRS comprises a DL PRS, and the DL PRS is indicated in the response message according to resource granularities of one or more of positioning frequency layer, transmission reception point (TRP), DL-PRS resource set, or DL-PRS resource.

22. The apparatus of claim 21, wherein the unsuitable PRS is indicated explicitly with a do not use (DNU) flag, the DNU flag is configured with associated validity criteria, and the validity criteria comprise one or more of a validity duration or a validity area.

23. The apparatus of claim 21, wherein one or more of:
the unsuitable PRS is indicated implicitly with the unsuitable PRS excluded from the positioning assistance data message or based on a previously transmitted positioning assistance data message; or
the unsuitable PRS is indicated implicitly by switching off TRPs or beams carrying DL-PRS resources, or muting the DL-PRS resources.

24. The apparatus of claim 21, wherein the unsuitable PRS is associated with pre-configured assistance data.

25. The apparatus of claim 16, wherein the at least one processor is operable to cause the apparatus to transmit an integrity result request for reporting of the RAT-dependent positioning integrity information.

26. The apparatus of claim 25, wherein the RAT dependent positioning integrity information comprises one or more of target integrity risk (TIR), alert limit (AL), protection level (PL), time to alert (TTA), availability of positioning service, or an indication of whether there is loss of integrity.

27. The apparatus of claim 25, wherein the integrity result request comprises an indication of frequency for reporting of the RAT-dependent positioning integrity information comprising aperiodic, one shot, periodic, or periodic based on one or more of an activation command or a deactivation command.

28. The apparatus of claim 16, wherein the at least one processor is operable to cause the apparatus to receive a report of RAT-dependent positioning integrity information.

29. A method performed by an apparatus, the method comprising:
receiving a request message for assistance data of one or more of radio access technology (RAT)-dependent positioning integrity information or integrity service alert information, wherein the request message comprises one or more of a type of positioning method an indication of frequency for reporting of the one or more of the RAT-dependent positioning integrity information or the integrity service alert information;
determining at least one positioning reference signal (PRS) unsuitable for satisfying an integrity condition; and
transmitting a response message indicating the unsuitable PRS.

30. The method of claim 29, wherein the unsuitable PRS comprises one or more of downlink (DL)-PRS, sounding reference signal (SRS) for positioning, or multiple input multiple output (MIMO) SRS.

31. The method of claim 29, wherein the request message comprises an indication that the one or more of the RAT-dependent positioning integrity information or the integrity service alert information is common to multiple positioning methods.

32. The method of claim 29, wherein the indication of frequency comprises an indication of one or more of aperiodic, one shot, periodic, or periodic based on one or more of an activation command or a deactivation command.

33. The method of claim 29, wherein the response message is transmitted using a long term evolution positioning protocol (LPP) user equipment (UE)-specific signaling or a broadcast signaling.

34. A user equipment (UE) for wireless communication, comprising:
at least one memory; and
at least one processor coupled with the at least one memory and operable to cause the UE to:
transmit a request message for assistance data for one or more of radio access technology (RAT)-dependent positioning integrity information or integrity service alert information, wherein the request message comprises one or more of a type of positioning method or an indication of frequency for reporting of one or more of the positioning integrity information or the integrity service alert information; and
receive a response message indicating at least one unsuitable positioning reference signal (PRS), wherein the unsuitable PRS is determined to be unsuitable for satisfying an integrity condition.

35. A method performed by a user equipment (UE), the method comprising:
transmitting a request message for assistance data for one or more of radio access technology (RAT)-dependent positioning integrity information or integrity service alert information, wherein the request message comprises one or more of a type of positioning method or an indication of frequency for reporting of one or more of the positioning integrity information or the integrity service alert information; and
receiving a response message indicating at least one unsuitable positioning reference signal (PRS), wherein the unsuitable PRS is determined to be unsuitable for satisfying an integrity condition.
